(19) United States
(12) Patent Application Publication
(10) Pub. No.: US 2025/0302054 A1
(43) Pub. Date: Oct. 2, 2025

(54) Rolling Pin Device

(71) Applicant: Trenton Peterson, Orleans, CA (US)

(72) Inventor: Trenton Peterson, Orleans, CA (US)

(21) Appl. No.: 18/620,853

(22) Filed: Mar. 28, 2024

(51) Int. Cl. A21C 3/02

(52) U.S. Cl. CPC A21C 3/021

(57) ABSTRACT

A rolling pin device includes a rolling pin that has a central portion and a pair of shaft portions each extending between the central portion and a respective one of a pair of knob portions. The central portion has a diameter that is greater than a diameter of each of the shaft portions such that each of the shaft portions is spaced above a support surface when the central portion is rolled along the support surface to roll dough that is positioned on the support surface. A pair of annular rings is provided and each of the annular rings extends around a respective one of the shaft portions. Each of the pair of annular rings is rotatable around the respective shaft portion to facilitate a user to grip each of the pair of annular rings to roll the rolling pin while keeping their hands motionless.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to rolling pin devices and more particularly pertains to a new rolling pin device for enhancing comfort for a user while employing a rolling pin. The device includes a rolling pin which has a central portion, a pair of shaft portions extending laterally away from the central portion and a pair of knob portions each attached to a respective shaft portion. The central portion and each of the knob portions rolls along a support surface for rolling dough. The device includes a pair of annular rings that are each positioned around a respective shaft portion for facilitating the user to grip while rolling the rolling pin.

### (2) Description of Related Art Including Information Disclosed Under 37 CFR 1.97 and 1.98

The prior art relates to rolling pin devices including a variety of rolling pins that each has a pair of grips that are rotatably attached to the rolling pin for gripping and a rolling pin that has shaft portions extending away from a central portion which can each be gripped and wheels attached to the shaft portions which roll along the support surface. In no instance does the prior art disclose a rolling pin which has a central portion, a pair of shaft portions and a pair of knob portions each attached to a respective shaft portion and a pair of annular rings each extending around a respective shaft portion which can each be gripped.

### BRIEF SUMMARY OF THE INVENTION

An embodiment of the disclosure meets the needs presented above by generally comprising a rolling pin that has a central portion and a pair of shaft portions each extending between the central portion and a respective one of a pair of knob portions. The central portion has a diameter that is greater than a diameter of each of the shaft portions such that each of the shaft portions is spaced above a support surface when the central portion is rolled along the support surface to roll dough that is positioned on the support surface. A pair of annular rings is provided and each of the annular rings extends around a respective one of the shaft portions. Each of the pair of annular rings is rotatable around the respective shaft portion to facilitate a user to grip each of the pair of annular rings to roll the rolling pin while keeping their hands motionless.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a rolling pin device according to an embodiment of the disclosure.

FIG. 2 is a front view of an embodiment of the disclosure.

FIG. 3 is a cross sectional view taken along line 3-3 of FIG. 2 of an embodiment of the disclosure.

FIG. 4 is a magnified detail view taken from circle 4 of FIG. 3 of an embodiment of the disclosure.

FIG. 5 is a perspective in-use view of an embodiment of the disclosure.

### DETAILED DESCRIPTION OF THE INVENTION

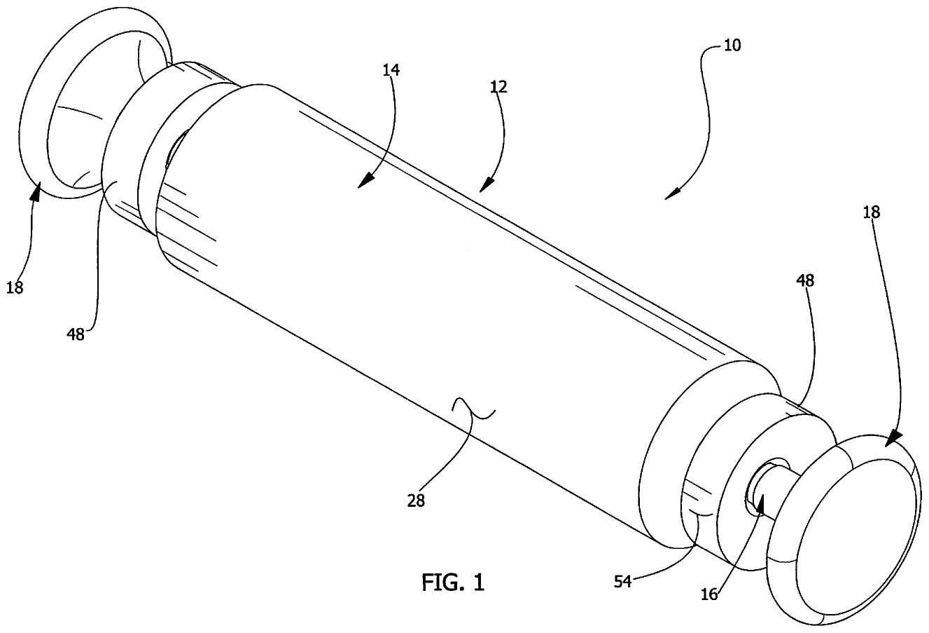

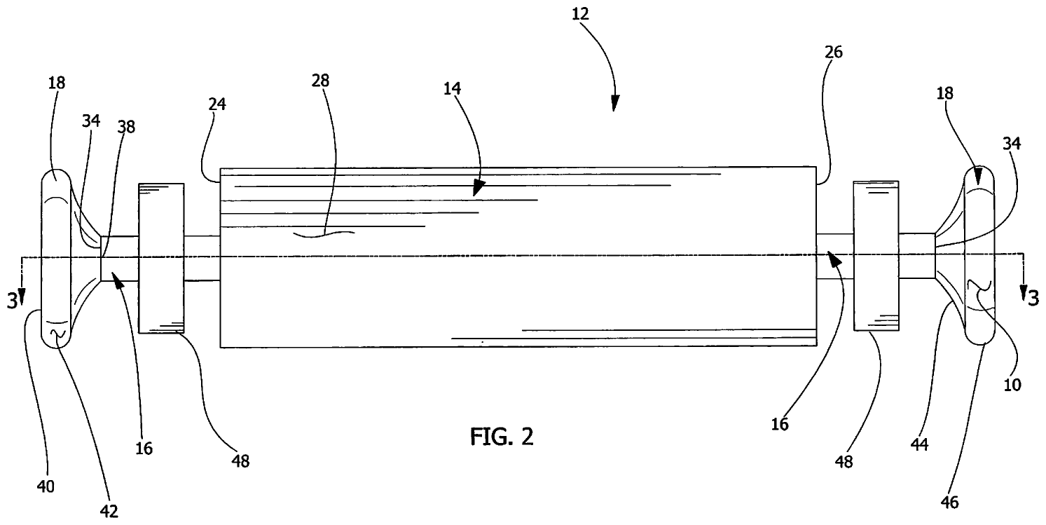

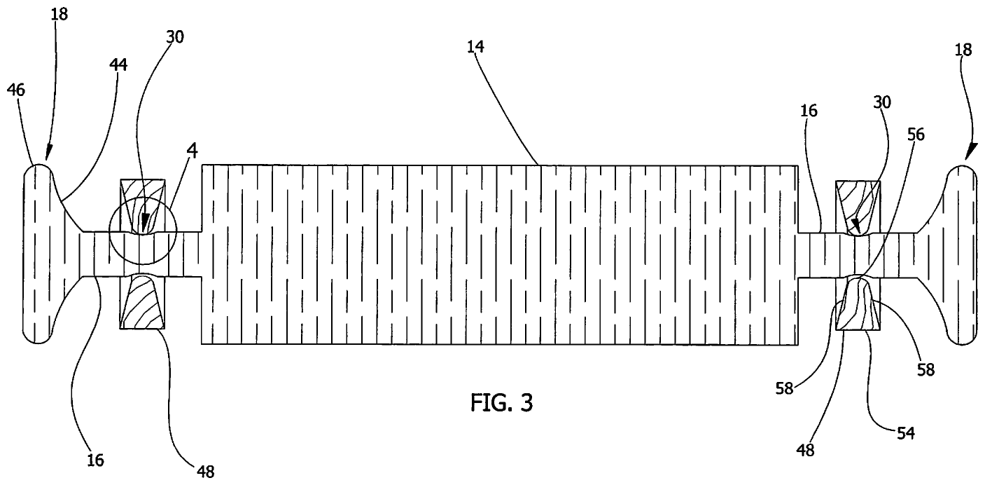

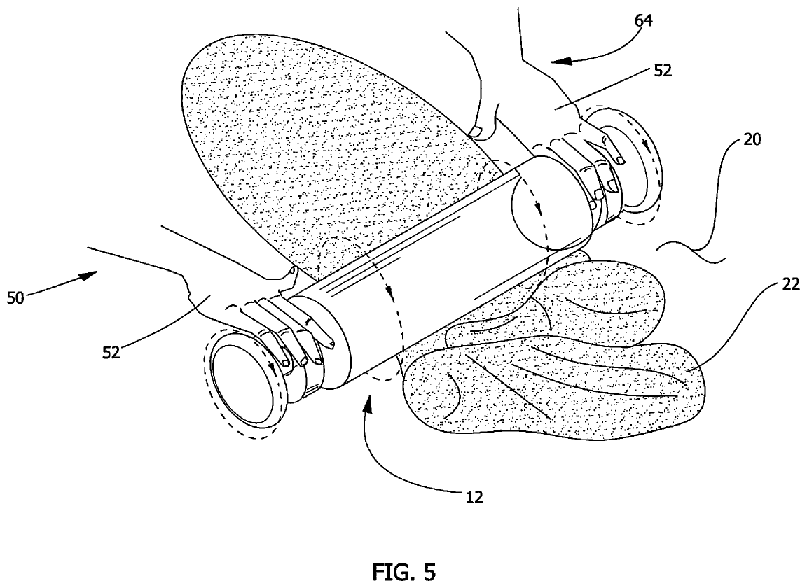

With reference now to the drawings, and in particular to FIGS. 1 through 5 thereof, a new rolling pin device embodying the principles and concepts of an embodiment of the disclosure and generally designated by the reference numeral 10 will be described.

As best illustrated in FIGS. 1 through 5, the rolling pin device 10 generally comprises a rolling pin 12 that has a central portion 14, a pair of shaft portions 16 and a pair of knob portions 18. Each of the shaft portions 16 extends between the central portion 14 and a respective one of the pair of knob portions 18. The central portion 14 has a diameter that is greater than a diameter of each of the shaft portions 16. In this way each of the shaft portions 16 is spaced above a support surface 20 when the central portion 14 is rolled along the support surface 20 to roll dough 22 that is positioned on the support surface 20. The support surface 20 may be a table, for example, or other horizontal support surface 20 and the dough 22 may be bread dough, crust dough or any other type of dough that is commonly rolled with a rolling pin 12. Additionally, the rolling pin 12 may be comprised of any species of wood or other type of resilient and fluid permeable material.

The central portion 14 has a first end 24, a second end 26 and an outer surface 28 extending between the first end 24 and the second end 26 and the outer surface 28 is continuously arcuate about an axis extending between the first end 24 and the second end 26 such that the central portion 14 has a cylindrical shape. Each of the shaft portions 16 extends away from a respective one of the first end 24 and the second end 26 and each of the shaft portions 16 is centrally located on the respective first end 24 and second end 26. Additionally, each of the shaft portions 16 has a recess 30 in an outside surface 32 of the shaft portions 16. The recess 30 associated with each of the shaft portions 16 is centrally positioned between the respective first end 24 and second end 26 of the central portion 14 and a distal end 34 of a respective one of the shaft portions 16. The recess 30 associated with each of the shaft portions 16 extends around a full circumference of the respective shaft portion 16 and the recess 30 associated with each of the shaft portions 16 has a bounding surface 36 that is concavely arcuate with respect to the outside surface 32 of the respective shaft portion 16.

Each of the knob portions 18 has a coupled end 38, a free end 40 and an exterior surface 42 extending between the coupled end 38 and the free end 40 and the exterior surface 42 has a first portion 44 and a second portion 46. The first portion 44 is associated with the coupled end 38 and the second portion 46 is associated with the free end 40. The coupled end 38 has a diameter that is less than a diameter of the free end 40 and the coupled end 38 of each of the knob portions 18 is attached to the distal end 34 of a respective one of the shaft portions 16. The first portion 44 slopes upwardly between the coupled end 38 and the second portion 46; the second portion 46 curves outwardly between the first portion 44 and the free end 40 to facilitate the second portion 46 associated with each of the knob portions 18 to roll along the support surface 20.

A pair of annular rings 48 is provided and each of the annular rings 48 extends around a respective one of the shaft portions 16. Each of the pair of annular rings 48 is rotatable around the respective shaft portion 16 to facilitate a user 50 to grip each of the pair of annular rings 48 to roll the rolling pin 12 while keeping their hands 52 motionless. Each of the pair of annular rings 48 has an outwardly facing surface 54, an inwardly facing surface 56 and a pair of lateral surfaces 58 each extending between the outwardly facing surface 54 and the inwardly facing surface 56. Each of the lateral surfaces 58 associated with a respective one of the pair of annular rings 48 angles inwardly between the outwardly facing surface 54 and the inwardly facing surface 56 associated with the respective annular ring 48.

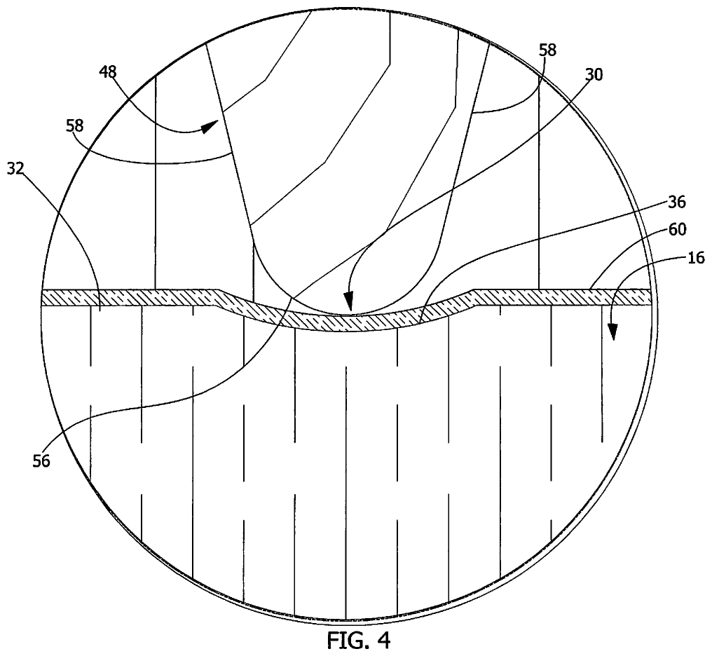

The inwardly facing surface 56 of each of the pair of annular rings 48 is rounded thereby facilitating the inwardly facing surface 56 associated with each of the pair of annular rings 48 to conform to curvature of the bounding surface 36 of the recess 30 in the respective shaft portion 16. In this way each of the pair of annular rings 48 can roll around the respective shaft portion 16. As is most clearly shown in FIG. 4, the outside surface 32 of each of the shaft portions 16 is treated with a fluid lubricant 60, including but not being limited to mineral oil or other type of fluid that can penetrate into the outside surface 32 of each of the shaft portions 16. In this way the inwardly facing surface 56 of each of the annular rings 48 is lubricated to slide along the bounding surface 36 of the recess 30 in the respective shaft portion 16. The outwardly facing surface 54 associated with each of the pair of annular rings 48 lies on a plane that is oriented parallel to the outside surface 32 of the respective shaft portion 16 to enhance comfort for the user's hands 52.

In use, the user 50 places each of their hands 52 on the outwardly facing surface 54 of the respective annular ring 48 to roll the rolling pin 12 back and forth along the support surface 20. Furthermore, each of the annular rings 48 rotates around the respective shaft portion 16 while the rolling pin 12 rolls back and forth along the support surface 20. In this way the user 50 can apply downward pressure on the rolling pin 12 for rolling the dough 22 while facilitating the rolling pin 12 to roll without being impeded by the user's hands 52. Thus, the user's hands 52 can remain motionless with respect to the rolling pin 12 while the dough 22 is being rolled for reducing stress and fatigue in the user's hands 52 and wrists 64.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A rolling pin device for reducing strain on a user while the user is rolling dough, said device comprising:
a rolling pin having a central portion and a pair of shaft portions each extending between said central portion and a respective one of a pair of knob portions, said central portion having a diameter being greater than a diameter of each of said shaft portions wherein each of said shaft portions is configured to be spaced above a support surface when said central portion is rolled along the support surface to roll dough that is positioned on the support surface; and
a pair of annular rings, each of said annular rings extending around a respective one of said shaft portions, each of said pair of annular rings being rotatable around said respective shaft portion wherein each of said pair of annular rings is configured to facilitate a user to grip each of said pair of annular rings to roll said rolling pin while keeping their hands motionless.

2. The device according to claim 1, wherein:
said central portion has a first end, a second end and an outer surface extending between said first end and said second end, said outer surface being continuously arcuate about an axis extending between said first end and said second end such that said central portion has a cylindrical shape;
each of said shaft portions extends away from a respective one of said first end and said second end, each of said shaft portions being centrally located on said respective first end and second end; and
each of said knob portions has a coupled end, a free end and an exterior surface extending between said coupled end and said free end, said coupled end of each of said knob portions being attached to a distal end of a respective one of said shaft portions.

3. The device according to claim 2, wherein:
each of said shaft portions has a recess in an outside surface of said shaft portions;
said recess associated with each of said shaft portions is centrally positioned between said respective first end and second end of said central portion and a distal end of a respective one of said shaft portions;
said recess associated with each of said shaft portions extends around a full circumference of said respective shaft portion; and
said recess associated with each of said shaft portions has a bounding surface being concavely arcuate with respect to said outside surface of said respective shaft portion.

4. The device according to claim 2, wherein:
said exterior surface associated with each of said pair of knob portions has a first portion and a second portion, said first portion being associated with said coupled end, said second portion being associated with said free end;
said coupled end has a diameter being less than a diameter of said free end;
said first portion slopes upwardly between said coupled end and said second portion; and
said second portion curves outwardly between said first portion and said free end wherein said second portion associated with each of said knob portions is configured to roll along the support surface.

5. The device according to claim 3, wherein:
each of said pair of annular rings has an outwardly facing surface and an inwardly facing surface and a pair of lateral surfaces each extending between said outwardly facing surface and said inwardly facing surface;
each of said lateral surfaces associated with a respective one of said pair of annular rings angles inwardly between said outwardly facing surface and said inwardly facing surface associated with said respective annular ring; and
said inwardly facing surface of each of said pair of annular rings being rounded thereby facilitating said inwardly facing surface associated with each of said pair of annular rings to conform to curvature of said bounding surface of said recess in said respective shaft portion thereby facilitating each of said pair of annular rings to roll around said respective shaft portion.

6. The device according to claim 5, wherein said outwardly facing surface associated with each of said pair of annular rings lies on a plane being oriented parallel to said outside surface of said respective shaft portion wherein said outwardly facing surface associated with each of said pair of annular rings is configured to enhance comfort for the user's hands.

7. A rolling pin device for reducing strain on a user while the user is rolling dough, said device comprising:
a rolling pin having a central portion and a pair of shaft portions each extending between said central portion and a respective one of a pair of knob portions, said central portion having a diameter being greater than a diameter of each of said shaft portions wherein each of said shaft portions is configured to be spaced above a support surface when said central portion is rolled along the support surface to roll dough that is positioned on the support surface, said central portion having a first end, a second end and an outer surface extending between said first end and said second end, said outer surface being continuously arcuate about an axis extending between said first end and said second end such that said central portion has a cylindrical shape, each of said shaft portions extending away from a respective one of said first end and said second end, each of said shaft portions being centrally located on said respective first end and second end, each of said shaft portions having a recess in an outside surface of said shaft portions, said recess associated with each of said shaft portions being centrally positioned between said respective first end and second end of said central portion and a distal end of a respective one of said shaft portions, said recess associated with each of said shaft portions extending around a full circumference of said respective shaft portion, said recess associated with each of said shaft portions having a bounding surface being concavely arcuate with respect to said outside surface of said respective shaft portion, each of said knob portions having a coupled end, a free end and an exterior surface extending between said coupled end and said free end, said exterior surface having a first portion and a second portion, said first portion being associated with said coupled end, said second portion being associated with said free end, said coupled end having a diameter being less than a diameter of said free end, said coupled end of each of said knob portions being attached to said distal end of a respective one of said shaft portions, said first portion sloping upwardly between said coupled end and said second portion, said second portion curving outwardly between said first portion and said free end wherein said second portion associated with each of said knob portions is configured to roll along the support surface; and
a pair of annular rings, each of said annular rings extending around a respective one of said shaft portions, each of said pair of annular rings being rotatable around said respective shaft portion wherein each of said pair of annular rings is configured to facilitate a user to grip each of said pair of annular rings to roll said rolling pin while keeping their hands motionless, each of said pair of annular rings having an outwardly facing surface and an inwardly facing surface and a pair of lateral surfaces each extending between said outwardly facing surface and said inwardly facing surface, each of said lateral surfaces associated with a respective one of said pair of annular rings angling inwardly between said outwardly facing surface and said inwardly facing surface associated with said respective annular ring, said inwardly facing surface of each of said pair of annular rings being rounded thereby facilitating said inwardly facing surface associated with each of said pair of annular rings to conform to curvature of said bounding surface of said recess in said respective shaft portion thereby facilitating each of said pair of annular rings to roll around said respective shaft portion, said outwardly facing surface associated with each of said pair of annular rings lying on a plane being oriented parallel to said outside surface of said respective shaft portion wherein said outwardly facing surface associated with each of said pair of annular rings is configured to enhance comfort for the user's hands.
